(19) United States
(12) Patent Application Publication
(10) Pub. No.: US 2009/0104501 A1
(43) Pub. Date: Apr. 23, 2009

(54) Fuel Cell System for Generating Electric Power for a Vehicle Constructed of Modules

(75) Inventors: Stefan GERHARDT, Westerstetten (DE); Dirk GRESSMANN, Filderstadt (DE); Alfred HAUG, Kirchheim (DE); Wolfgang SCHMID, Illerkirchberg (DE); Timo TOMASCHAEFSKY, Dettingen (DE); Peter WISSHAK, Baltmannsweiler (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLER AG, Stuttgart (DE); FORD GLOBAL TECHNOLOGIES, LLC, Dearborn, MI (US)

(21) Appl. No.: 11/877,513

(22) Filed: Oct. 23, 2007

(51) Int. Cl. H01M 8/02; B21D 21/00

(52) U.S. Cl. 429/34; 429/12; 29/428

(57) ABSTRACT

A fuel cell system for generating electric power for a vehicle is constructed of modules. The modules being configured such that, depending on the space available in the vehicle, they are arranged in different directions and at different mutual distances above one another and/or side-by-side.

### BACKGROUND OF THE INVENTION

The invention relates to a fuel cell system for generating electric power for a vehicle constructed of modules.

Fuel cell systems in vehicles are usually used to generate electric power to drive the vehicle. The construction of fuel cell systems typically is very complex. Published U.S. Patent Application No. 2007/0042236 A1 describes a modular construction of a fuel cell system. Published U.S. Patent Application No. 2003/0164255 A1 describes a modular construction in which a fuel cell system divided in modules is also installed.

However, it is not customary, or economic, to design a fuel cell system, such as described in Published U.S. Patent application 2003/0164255 A1, for each type of vehicle. On the contrary, it should be possible to simply use fuel cell systems in almost all vehicles instead of the previous internal-combustion engine.

It is therefore an object of the invention to create a fuel cell system for generating electric power for a vehicle, which permits maximal flexibility at minimal expense.

Thus, another object of the invention is to make it possible to integrate the same fuel cell system in different types of vehicles by means of slight adaptations.

### SUMMARY OF THE INVENTION

These and other objects and advantages are achieved by the fuel cell system according to the invention, in which the modules are constructed so that they can be arranged in different directions and at different mutual distances above one another and/or side-by-side, depending on the available space in the vehicle. With such a construction, full flexibility can be achieved with minimal expenditures and costs. Each module may have the same (uniform) construction, irrespective of how it is later integrated in the vehicle. As a result, depending on the vertical or horizontal position, sequence and spacing of the modules, only the pipework and the wiring need to be mutually adapted.

### BRIEF DESCRIPTION OF THE DRAWINGS

FIG. 1 shows a vertical construction of a modular fuel cell system;

FIG. 2 shows a horizontal construction of a modular fuel cell system;

FIG. 3 shows the arrangement of the connections in the case of the vertical construction; and

FIG. 4 illustrates the arrangement of the connections in the case of the horizontal construction.

### DETAILED DESCRIPTION OF THE INVENTION

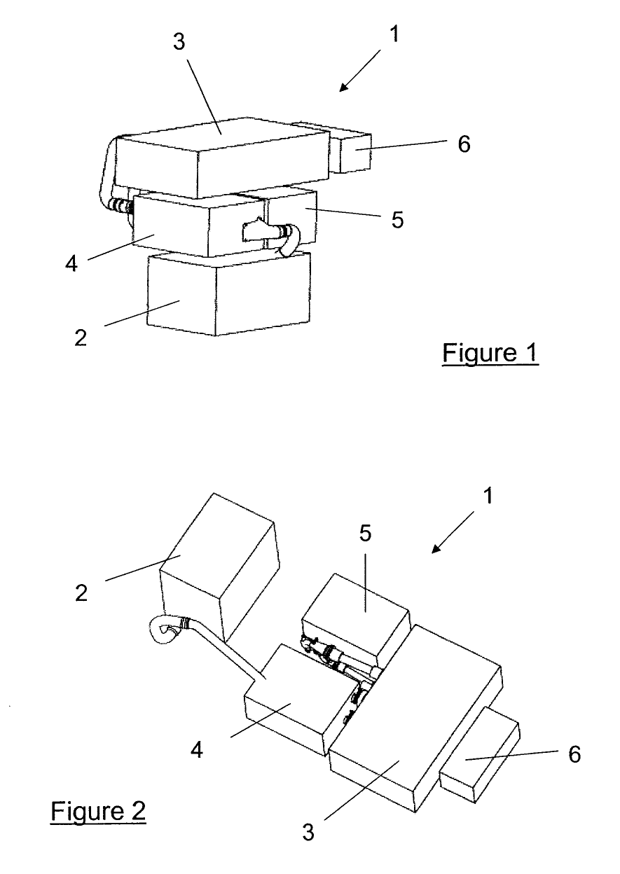

FIG. 1 is a schematic view of a vertically stacked structure of a fuel cell system 1. As an example, the fuel cell system 1 consists in this case of an air module 2, a fuel cell module 3 containing a stack of individual fuel cells, a moistening module 4, an anode module 5 and an electric/electronic module 6.

Furthermore, the fuel cell system 1 may have additional modules (not shown), such as a tank module which has all components for the storage of hydrogen.

In each of the modules, all components typical of the module are combined in one structure, particularly in a housing, together with possible auxiliary components, such as a sensor system, a control system, a cooling system, etc.

The fuel cell module 3 has at least one stack of individual cells. In addition to the connecting flanges for the feeding and discharging of gas, it may also have sensors and, as required, valves for controlling gas flows or a cooling water flow.

The anode module 5 has the devices for feeding and removing hydrogen. It may optionally also comprise a closed loop (anode loop) for the recirculation of unconsumed hydrogen, possibly together with valves, hydrogen pumps and/or hydrogen fans. Also components for the product water or waste gas management, such as water separators or an exhaust gas afterburning system, may be part of the anode module.

The air module 2 contains all devices for the feeding and the removal of air. In particular, these may be air filters, air coolers, a compressor or an electric turbo compressor. The exhaust air side of the air module may include, for example, a turbine for recovering pressure energy, as required, coupled with the turbo compressor, or a pressure control valve. Components for the product water or exhaust gas management, such as water separators or an exhaust gas afterburning system may also be part of the air module. However, it would also be possible to combine the latter in their own exhaust gas module to process anode exhaust gas and exhaust air.

The moistening module 4 is used to moisten the air flowing into the fuel cell module 3. It typically comprises a water-vapor-permeable membrane by which moisture from the anode exhaust gas and/or the exhaust air is transmitted to the inflowing air. Frequently, a bypass, together with a valve and a control, is also situated in the moistening module, so that the moisture of the air can be adjusted for the fuel cell module 3 by means of the ratio of moistened air and air flowing through the bypass.

The electric/electronic module 6 has elements for transmitting the generated power. It may also have elements for detecting and processing sensor data and for controlling the additional modules 2, 3, 4, 5. In this preferred construction, it represents at least a part of the control unit for the fuel cell system.

Each respective module 2, 3, 4, 5, 6 has a sturdy, particularly a self-supporting, construction and is mounted as a whole in the vehicle. The vehicle itself may generally be any vehicle, irrespective of whether it operates on land, in or on the water or in the air.

FIG. 2 shows another possible arrangement of the modules 2, 3, 4, 5, 6, in which the respective components are disposed mutually horizontally, with the air module being at a larger distance from the other modules than the latter are from one another. Such an arrangement can ideally utilize the space in a vehicle—for example, the underbody area.

The stacking capability of the respective uniformly constructed modules 2, 3, 4, 5, 6 in different sequences, directions and distances is ideal for adapting the fuel cell system rapidly and easily to different vehicles, vehicle types or to vehicles produced by different manufacturers. On the one hand, this technique permits the installation of the fuel cell system in conventional vehicles in large numbers, and at reasonable cost. On the other hand, also the respective uniformly constructed components can be used for different vehicles and can therefore be produced less expensively in larger numbers.

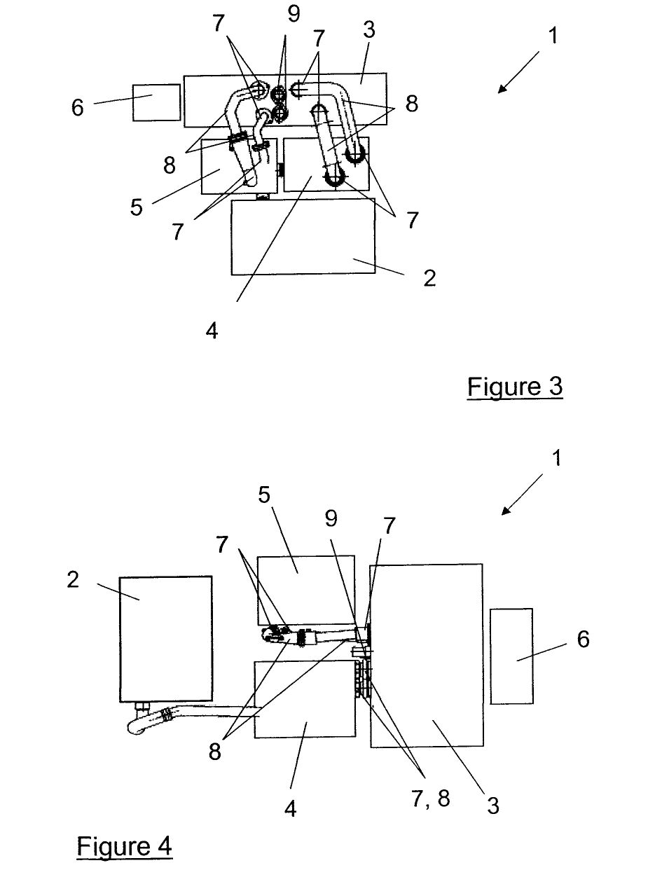

FIG. 3 is a lateral view of the vertically stacked modular fuel cell system 1. The connection elements 7 for the feeding and removal of gases are arranged centrally on one side of the modules 2, 3, 4, 5, 6, particularly the fuel cell module 3. The pipework 8 to the other modules can therefore be implemented in a simple manner.

FIG. 4 is a top view of the horizontal construction. In this case, the same connection elements 7 are mutually connected by means of an only slightly changed pipework 8.

In order to obtain an ideal construction of the pipework 8, it is advantageous for all connections of the gases/liquids flowing to the fuel cell module 3 or coming from the fuel cell module 3 to be arranged on the same side of each module 2, 3, 4, 5, so that the pipework does not have to extend around the modules 2, 3, 4, 6. In addition to the connections 7 together with the pipework 8, FIGS. 3 and 4 also show connections 9 which are connected with a cooling module (not shown), in order to cool the fuel cell module 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system for generating electric power for a vehicle, said fuel cell system comprising a plurality of modules, wherein:
the modules are arranged in the vehicle in directions and at distances relative to one another depending on the space available in the vehicle; and
the modules are arranged in a relative orientation that is at least one above one another and side-by-side.

2. The fuel cell system according to claim 1, wherein:
independently of their arrangement, the respective modules always have an invariable structure; and
only mutual connection of the modules has a changed construction depending on the arrangement.

3. The fuel cell system according to claim 2, wherein the fuel cell system includes at least one fuel cell module having a stack of individual cells, an anode module having fuel feeding and fuel removal apparatus, a tank module having a hydrogen storage device, and an air module having air feeding and air removal apparatus.

4. The fuel cell system according to claim 3, further comprising at least one of a moistening module for moistening air flowing into the fuel cell module, and an electric/electronics module.

5. The fuel cell system according to claim 3, wherein the anode module has an anode gas recirculation device.

6. The fuel cell system according to claim 4, wherein the electric/electronic module includes elements for transmitting generated power.

7. The fuel cell system according to claim 4, wherein the electric/electronic module includes elements for transmitting generated power, for detecting and processing sensor data and for controlling other modules.

8. The fuel cell system according to claim 1, wherein connection elements for gases and liquids are arranged on the fuel cell module, in each case centrally on one side of the fuel cell module.

9. The fuel cell system according to claim 8, wherein connection elements for gases and liquids, which flow to the fuel cell module or flow from the fuel cell module to the modules, are arranged on the modules, in each case on one of the sides of the respective module.

10. A vehicle having a fuel cell system for supplying electric power to operate vehicle systems, wherein:
said fuel cell system comprises a plurality of modules each module being configured to perform a different function within the fuel cell system;
said plurality of modules includes at least an air-processing module, a fuel cell module containing a stack of individual fuel cells, a humidification module, a fuel processing module and an electric/electronics module;
each module contains components for performing those task that are included in the functionality of that module; and
said modules are configured such that they are mountable and interconnectable in positions and spacing relative to each other, which positions and spacing are variable depending on the type of vehicle in which the fuel cell system is to be mounted.

11. The vehicle having a fuel cell system for supplying electric power to operate vehicle systems according to claim 10, wherein:
said modules are deployable in different directions relative to each other; and
in a deployed condition in a vehicle, said modules are deployable above one another or side-by-side.

12. A method of installing a fuel cell system in a vehicle, said method comprising:
providing said fuel cell system in the form of a plurality of modules, each module being configured to perform a different function within said fuel cell system, said modules collectively being operable to generate electric power to said vehicle; and
mounting each one of said modules within said vehicle in a space that is sufficient to accommodate said one of said modules, whereby an overall configuration of said fuel cell system, including position and spacing of said modules relative to each other within the vehicle, are determined by an internal configuration of the vehicle in which the system is installed; and
wherein, said modules are interconnected by connecting elements for gases and liquids that flow between the modules, said connecting elements having a configuration that is determined by said position and spacing of said modules in a mounted state in said vehicle.
